(19) United States
(12) Patent Application Publication
(10) Pub. No.: US 2001/0048607 A1
(43) Pub. Date: Dec. 6, 2001

(54) Electronic voltage convertor for low current electronic equipment

(76) Inventor: Alejandro Jorge Zatonyl, Miami, FL (US)

Correspondence Address: MALLOY & MALLOY, P.A., 2800 S. W. Third Avenue, Historic Coral Way, Miami, FL, 33129, US

(21) Appl. No.: 09/867,339

(22) Filed: May 29, 2001

(30) Foreign Application Priority Data
May 31, 2000 (AR) P000102702

(51) Int. Cl. H02M 7/537

(52) U.S. Cl. 363/131

(57) ABSTRACT

An electronic voltage convertor designed to increase the voltage from a direct current power supply for use by low current electrical equipment, such as compact flourescent lamps. The electronic voltage convertor includes a circuit having an inner circuit and an outer circuit which are at least partially interconnected by a resistor. The inner circuit includes a transistor and a primary coil of a dual coil transformer, connected between the positive terminal and the ground of the direct current power supply. The outer circuit includes a diode, a secondary coil of the dual coil transformer, an electrolytic capacitor, and a plurality of standard capacitors. The primary and secondary coils are operatively associated such that the voltage across the primary coil is increased by the secondary coil before discharge from the circuit.

### BACKGROUND OF THE INVENTION

This application is based on Patent Application No. P000102702 filed by Alejandro Jorge Zatonyl on May 31, 2000, with the Administracion Nacional de Patentes in the Republic of Argentina, and the benefit of this filing date for the present application is hereby claimed under 35 U.S.C. §119.

1. Field of the Invention

The present invention is directed to an electronic voltage convertor designed to increase the voltage from a direct current power supply that may be utilized by electronic equipment requiring a low current, such as compact flourescent lamps.

2. Description of the Related Art

Electronic voltage convertors have numerous applications, in particular, they are often utilized to convert conventional low voltage direct current (“DC”) power supplies so they may pro vide power to a variety of electrical equipment. An electronic voltage convertor significantly increase the voltage from a DC power supply so it is sufficient to operate various electrical equipment. A common application of electronic voltage convertors is to supply power to mobile, auxiliary and emergency lighting systems. Examples of mobile systems include those used on public transportation vehicles such as buses, trains, ships and airplanes, or in personal recreational vehicles. In addition, electronic voltage convertors are used to supply power to auxiliary and/or emergency lighting systems commonly installed in commercial, industrial and residential buildings.

The electronic voltage convertors available at the present time generally have a minimum power output in the range of SOW, which while suitable for larger applications do not lend themselves for operating electronic equipment requiring a low current power supply. For example, the minimum 50 W electronic voltage convertor could not be used to supply power to a single compact flourescent lamp, which are typically rated at less than 20 W, some as low as 3 W, because the convertor will output 50 W to the light, overpowering it and causing the lamp to burn out.

Another feature of the electronic voltage convertors currently in use is a continuous draw of energy from the DC power supply, even when the electronic equipment connected to the convertor is switched off. The available electronic voltage convertors have an internal circuit structure that is constantly open which results in the continuous draw of current from the DC power supply. As may be appreciated, a continuous draw of current from a DC power supply results in a reduction in the useful life of a non-rechargeable DC power supply, as are often employed for auxiliary and/or emergency lighting systems. Thus, the potential exists for an auxiliary and/or emergency lighting system to fail when needed because the DC power supply has been depleted by the electronic voltage convertor.

A further feature inherent in currently available electronic voltage convertors, as a result of the relatively high minimum power output and the continuous draw of current from the DC power supply, is the generation of heat by the convertor circuit. This creates a potential hazard when a convertor is installed in areas where explosive gases may be present, which is common in many industrial installations requiring auxiliary or emergency lighting systems.

Additionally, the relatively high minimum power output of the electronic voltage convertors in use today result in a device that is often too large for a number of applications in which an electronic voltage convertor would be useful, such as flashlights and photographic equipment.

Therefore, it would be beneficial to provide an electronic voltage convertor that is suitable for use with a variety of electrical equipment requiring a low current power supply, such as compact flourescent lamps. It would also be advantageous to provide an electronic voltage convertor that does not continuously draw current from a DC power supply when the electronic equipment it is connected to is switched off. Another benefit would be to provide an electronic voltage convertor that generates little to no heat, regardless of whether the electrical equipment connected to the convertor is switched on or off. Furthermore, it would be desirable to provide an electronic voltage convertor that is small in size so it may be incorporated in flashlights, photographic equipment, or other electronic equipment where size is a consideration.

### SUMMARY OF THE INVENTION

The present invention relates to a circuit for an electronic voltage convertor for use with electrical equipment requiring a low current power supply, such as compact flourescent lamps. The circuit includes a transistor, a dual coil transformer, a diode, an electrolytic capacitor, a plurality of standard capacitors and at least one resistor. The circuit is structured to increase the voltage from a direct current power supply. Specifically, the present invention is designed to supply power to electronic equipment requiring a low current, such as compact flourescent lamps.

The present invention is structured with an inner circuit operatively associated with an outer circuit. At least one resistor is included in the present invention which allows operative association between the inner and outer circuits. The inner circuit includes a transistor, structured to supply power to a primary coil of a dual coil transformer, and an output ground. The inner circuit is activated by a DC power supply which is connected to an emitter lead of the transistor via a positive input lead. The transistor further includes a collector lead which supplies power from the transistor to the primary coil of the dual coil transformer, which is operatively associated with a secondary coil of the dual coil transformer. The inner circuit terminates at an input ground of the DC power supply, which forms a common ground with an output ground of the circuit. A base lead of the transistor is disposed interconnecting the outer circuit and further providing operative association between the inner and outer circuits.

The outer circuit of the present invention includes the plurality of standard capacitors, the diode, the secondary coil of the dual coil transformer, and the electrolytic capacitor. Similar to the inner circuit, the outer circuit is activated by the DC power supply connected to the outer circuit by the positive input lead. The first component of the outer circuit is a first standard capacitor, which is connected in series to a combination of the diode and a second standard capacitor, the combination being connected in parallel. The base lead from the transistor is connected to the outer circuit after the first standard capacitor and before any other component in the outer circuit. The diode of the present invention is structured to rectify the frequency of the voltage prior to being output from the circuit to the low current electronic equipment. Further, the diode is structured to minimize the generation of the high frequencies generated by the circuit, which may interfere with radio or television signals in the area.

Following the combination of the diode and the second standard capacitor, the secondary coil is connected in series to the outer circuit. The secondary coil is further connected to a positive output lead of the circuit. A third standard capacitor is connected in series between the positive output lead and the common ground, and an electrolytic capacitor is connected in series between the common ground and the positive input lead, to complete the outer circuit.

As previously noted, the two coil transformer includes the primary coil and the secondary coil, being disposed in the inner and outer circuits, respectively. The primary coil is connected in series to the collector lead of the transistor, which activates the primary coil. The secondary coil is disposed to increase the voltage of the primary coil and transfer the amplified voltage to the positive output lead from the circuit to the low current electronic equipment. The voltage supplied at the positive output lead is controlled by the number of windings on the primary and secondary coils, allowing the present invention to be utilized to produce either 110V, 120V, 220V, or other voltages, as required.

The electrolytic capacitor of the present invention is connected in series between the common ground and the positive input lead and functions as an electronic filter for the current of the circuit. Additionally, as noted above, at least one resistor is included in the present invention at least partially operatively associate the inner and outer circuits. The resistor has a first connection point located in the inner circuit between the primary coil and the common ground, and a second connection point located between the first standard capacitor and the interconnection of the base lead of the transistor to the outer circuit. The resistor is structured to minimize or eliminate the continuous draw of current from the DC power supply by the circuit when the electronic equipment is switched off. The elimination of this continuous power draw also reduces the overall amount of heat generated by the circuit.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic of a preferred embodiment of the present invention.

FIG. 2 is a schematic of an alternate embodiment of the present invention.

FIG. 3 is a schematic of an alternate configuration of the embodiment of the present invention illustrated in FIG. 1.

FIG. 4 is a schematic of an alternate configuration of the present invention illustrated in FIG. 2.

FIG. 5 is a schematic of the present invention illustrating the incorporation of an electronic voltage regulator.

Like reference numerals refer to like parts throughout the several views of the drawings.

### DETAILED DESCRIPTION OF THE PREFERRED EMBODIMENT

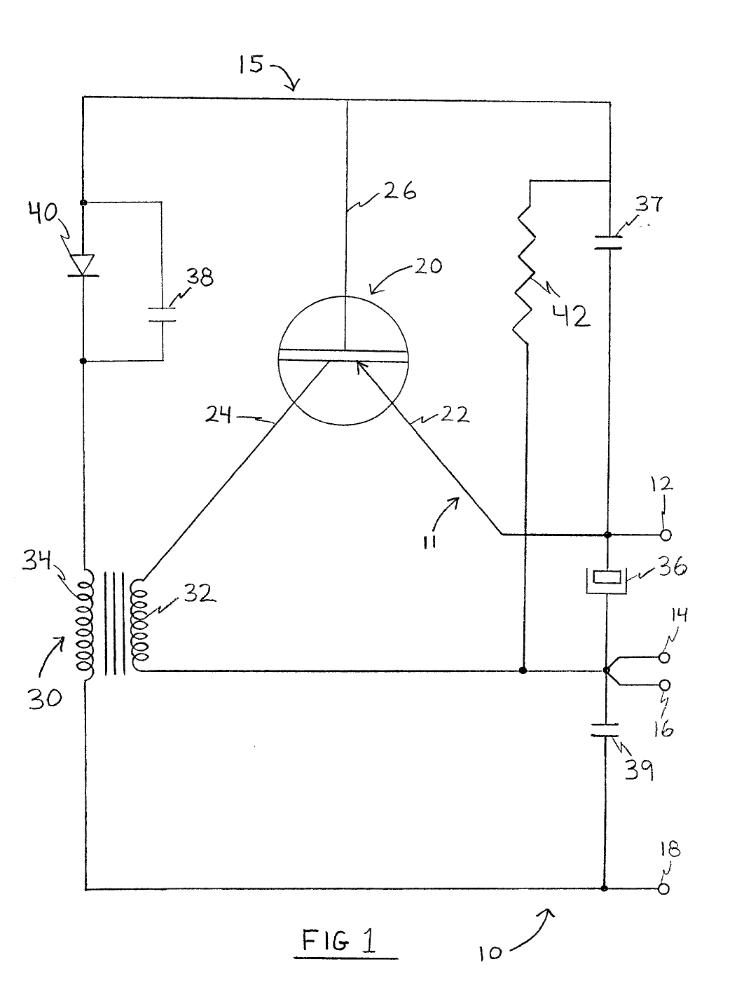

The present invention is directed to an electronic voltage convertor for low current electrical equipment comprising an electrical circuit, generally shown as 10 throughout the Figures. The circuit 10 is designed to increase the voltage from a DC power supply for use by electrical equipment requiring a low current power supply. The circuit 10 may be generally described as comprising an inner circuit 11 and an outer circuit 15, as shown in FIGS. 1-4. The inner circuit 11 includes a transistor, generally shown as 20, and a primary coil 32 of a dual coil transformer, generally shown as 30. The outer circuit includes a diode 40, a secondary coil 34 of the dual coil transformer 30, an electrolytic capacitor 36, and a plurality of standard capacitors 37, 38, 39. The standard capacitors 37, 38, are polyester capacitors in a preferred embodiment of the present invention. The circuit 10 of the present invention further includes at least one resistor 42 interconnecting the inner circuit 11 and outer circuit 15, such that they are at least partially operatively associated. The circuit 10 has a plurality of input and output leads providing connection points to and from the circuit 10, respectively. The circuit 10 includes a positive input lead 12 connected to the positive terminal of the DC power source, and an input ground 14 and output ground 16, forming a common ground interconnected to the ground of the DC power supply. The positive input lead 12 is connected to the inner circuit 11 at an emitter lead 22 of the transistor 20, and to the outer circuit 15 at a first standard capacitor 37, as illustrated in FIG. 1-4. The inner circuit 11 further includes a collector lead 24 of the transistor 20 connected in series with a primary coil 32 of the dual coil transformer 30. The primary coil 32 is activated by the transistor 20 through the collector lead 24, and is operatively associated with the secondary coil 34 which produces an increase in the voltage supplied by the DC power source. The transistor 20 further includes a base lead 26 interconnecting and further operatively associating the inner circuit 11 and the outer circuit 15, as illustrated in FIGS. 1-4. The transistor 20 belongs to the class of transistors utilized to amplify or regulate voltage, preferably being structured to operate in the range of approximately 100V to 400V. By way of example only, the present invention may utilize type TiP 41 or TiP 42, or more powerful type 2955 or 3055 transistors, however, alternative transistors producing the required effect exist.

As noted above, the outer circuit 15 includes the diode 40, the secondary coil 34 of the dual coil transformer 30, the electrolytic capacitor 36, and the plurality of standard capacitors 37, 38, 39. The outer circuit 15 is connected to the DC power supply through the positive input lead 12 to the first standard capacitor 37. The first standard capacitor 37 is then connected in series to the combination of the diode 40 and a second standard capacitor 38, wherein the components of the combination are connected in parallel with one another, as illustrated throughout the Figures. The diode 40 is structured to minimize the generation of the high frequencies created by the circuit which may interfere with the reception of radio and television signals in the area. In a preferred embodiment, the diode 40 operates in the range of approximately 1000V at 1.0 A to 1.5 A, however, alternate operating ranges may be utilized within the intended scope of the present invention. Additionally, the first standard capacitor is preferably rated in the range of approximately 0.001 μF to 0.056 μF.

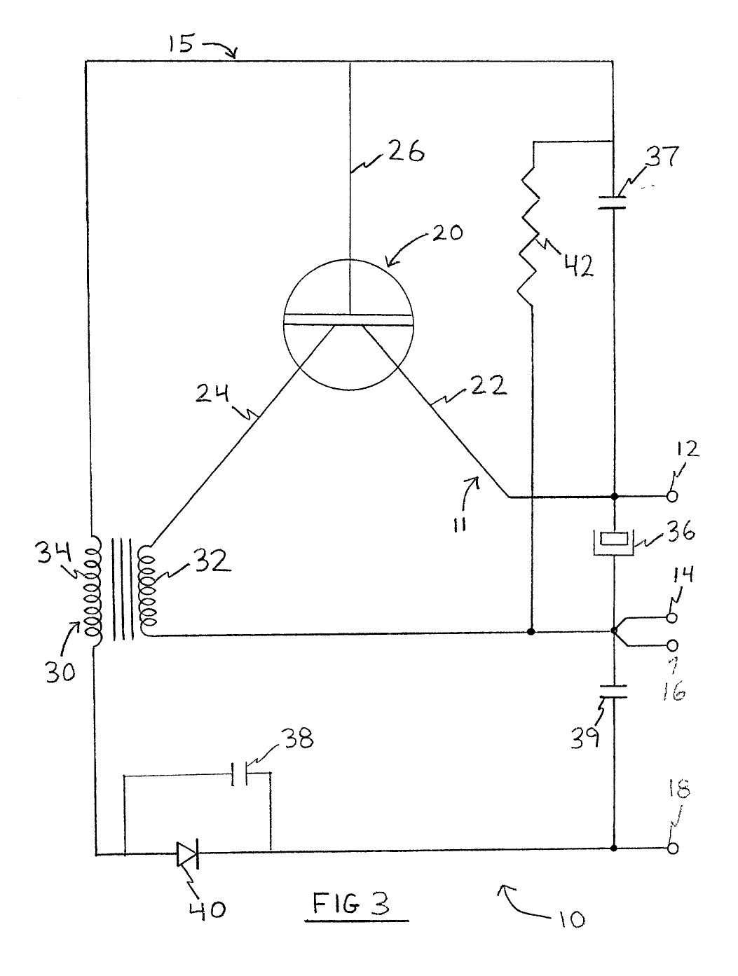

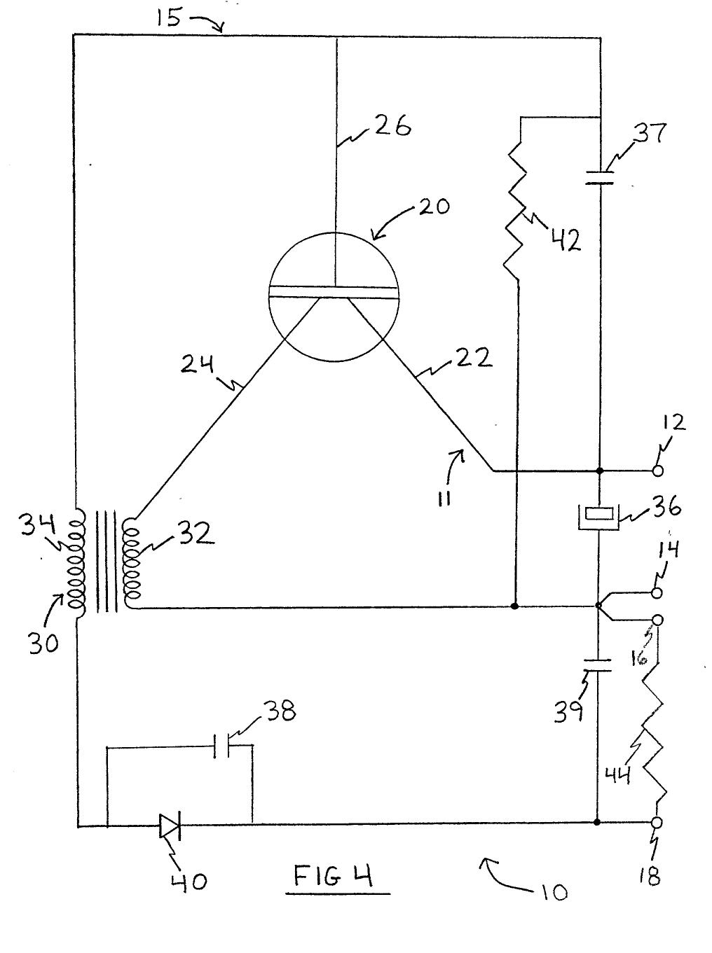

Next, the secondary coil 34 of the transformer 30 is connected in series following the combination of the diode 40 and the second standard capacitor 38. The secondary coil 34 is operatively associated with the primary coil 32 and is structured to produce an increase in the voltage supplied by the DC power source, prior to discharge from the circuit 10 through positive output lead 18. In an alternate embodiment, the parallel combination of the diode 40 and the second standard capacitor 38 are connected in series between the secondary coil of the transformer 30 and the positive output lead 18, as illustrated in FIGS. 3 and 4. The second standard capacitor, by way of example, is preferably rated in the range of approximately 0.01 μF to 0.056 μF.

The dual coil transformer 30 of the present invention, as previously noted, is structured to produce an increase in the voltage supplied by the DC power supply, which is typically a 12VDC power supply. The transformer 30 of the present invention may utilize either straight ferrous bar cores, closed loop ferrous nucleus cores, or standard toroidal transformer cores. The transformer 30 is tuned to produce an output voltage of 110V or 120V, as typically required in the United States, or 220V as typically required in many other parts of the world. The transformer 30 may also be tuned to produce any one of a variety of additional output voltages, for example, 200V, 500V, 1200V, 2000V, etc., as may be required by specific applications. The transformer 30 is tuned to produce the desired output voltage by varying the diameter and the number of wire coils wound around the cores of the primary coil 32 and the secondary coil 34, respectively. In one embodiment of the present invention, utilizing a straight ferrous bar core, the primary coil 32 includes approximately 25 and 50 windings of wire having a diameter in the range of 0.20 mm and 0.50 mm, while the secondary coil 34 includes approximately 450 and 850 windings of wire having a diameter in the range of 0.18 mm and 0.30 mm. In an alternate embodiment, utilizing a closed loop ferrous nucleus core, the primary coil 32 includes approximately 10 and 30 windings of wire having a diameter in the range of 0.20 mm and 0.50 mm, while the secondary coil 34 includes approximately 250 and 450 windings of wire having a diameter in the range of 0.15 mm and 0.30 mm. A preferred embodiment of the present invention comprises coated copper wire around the dual coil transformer 30 coils, however, other electrically conductive materials may be utilized.

The outer circuit 15 of the present invention further includes a third standard capacitor 39 and the electrolytic capacitor 36. The third standard capacitor 39 is connected in series to the outer circuit 15 between the positive output lead and the common ground and the electrolytic capacitor 36 is connected in series between the common ground and the positive input lead 12 to complete the outer circuit 15. The third standard capacitor 39 is structured to further minimize the high frequencies generated by the circuit 10 of the present invention. In a preferred embodiment, the third capacitor is rated in the range of approximately 0.18 μF to 0.33 μF. The electrolytic capacitor 36 is structured to function as an electronic filter for the current through the circuit 10 of the present invention. The electrolytic capacitor may be selected from, but is not limited to, the range of approximately 47 μF to 200 μF. Further, the electrolytic capacitor may be either polarized or non-polarized.

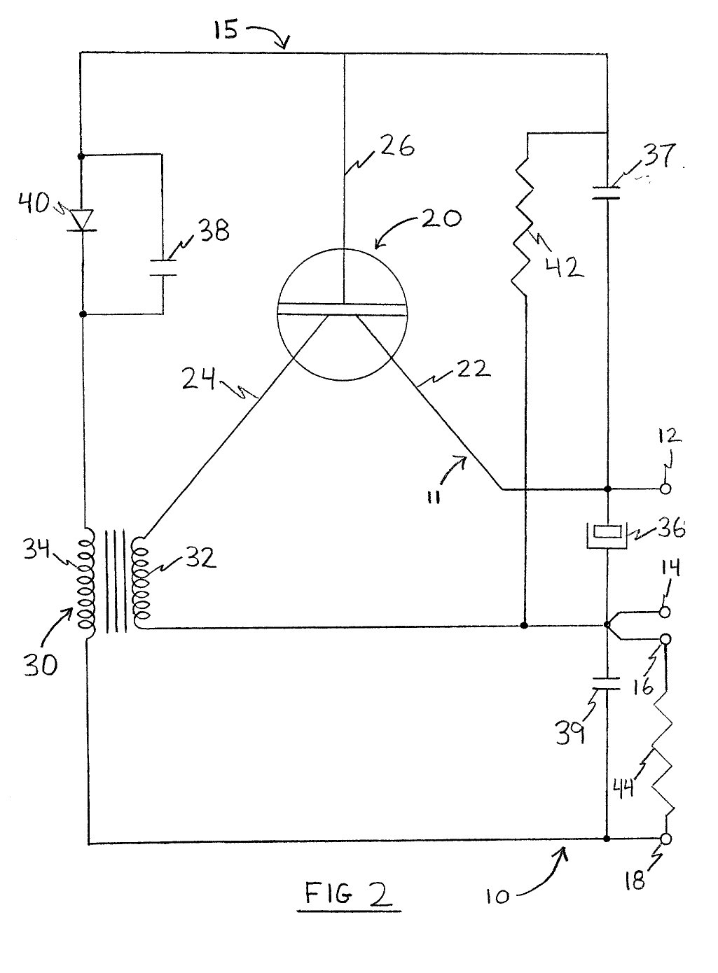

The inner circuit 11 and the outer circuit 15 of the present invention are at least partially operatively associated as a result of their interconnection by resistor 42. An alternate embodiment of the present invention includes a second resistor 44 which is utilized to bridge the connection between the positive output lead 18 and the output ground 16, as illustrated in FIGS. 2 and 4. The resistors 42, 44 operate to minimize and/or eliminate the draw of current by the circuit 10 from the DC power supply when the electrical equipment connected to the circuit 10 is switched off. The resistors 42, 44 may be selected in the range of approximately 120 kΩ to 1 MΩ.

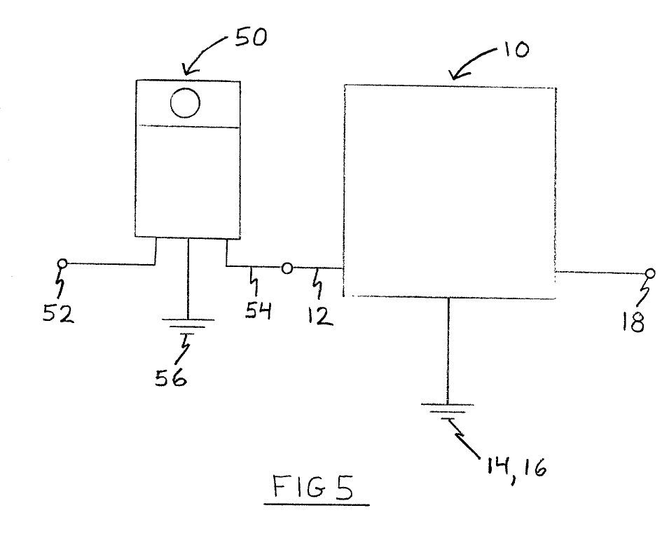

While the preferred embodiment of the present invention contemplates only the circuit 10 interconnected between the DC power source and the low current electrical equipment, an alternative configuration may include an electronic voltage regulator 50, as illustrated in FIG. 5. This configuration is particularly useful in applications where the DC power supply is connected to an alternator and/or generator, as is often common in mobile applications. This is due to the fact that the acceleration or deceleration of the motor used to drive the alternator and/or generator can cause fluctuations in the voltage output of the DC power supply, thus causing fluctuations in the input voltage to the circuit 10. As a result, even relatively minor fluctuations in the voltage output from the DC power supply will be significantly amplified by the circuit 10 prior to transfer to the low current electrical equipment. This may merely result in erratic operation of the electrical equipment, such as flickering lights, or, in more extreme instances, it may result in complete failure of the electrical equipment due to overload.

To alleviate potential operating problems, the DC power supply may be initially connected to a positive input lead 52 of the electronic voltage regulator 50. The voltage regulator output lead 54 is then connected to the positive input lead 12 of the circuit 10 to assure a constant voltage power supply. The low voltage electronic equipment may then be connected to the positive output 18 and common ground of the circuit 10, as in the above embodiments. The electronic voltage regulator 50 may comprise a voltage regulator transistor chip, in one embodiment of this alternate configuration.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A circuit for an electronic voltage convertor for low current electrical equipment, said circuit comprising:
a) an inner circuit operatively associated with an outer circuit;
b) said inner and outer circuits engaging a DC power supply;
c) said inner circuit comprising a transistor operatively associated with a transformer;
e) said outer circuit comprising a plurality of standard capacitors operatively associated with a diode and said transformer;
f) said outer circuit further comprising an electrolytic capacitor connected in series to said outer circuit; and
g) said circuit comprising at least one resistor interconnecting said inner and outer circuits.

2. A circuit as recited in claim 1 wherein said transformer is disposed to amplify a voltage applied to the circuit from the DC power supply.

3. A circuit as recited in claim 2 wherein said transformer further comprises a dual coil transformer.

4. A circuit as recited in claim 3 wherein said dual coil transformer comprises a primary coil.

5. A circuit as recited in claim 4 wherein said dual coil transformer further comprises a secondary coil, said secondary coil disposed to amplify a voltage of said primary coil.

6. A circuit as recited in claim 3 wherein said transistor is structured to transfer energy from the DC power supply to said dual coil transformer.

7. A circuit as recited in claim 6 wherein said transistor comprises an emitter lead and a collector lead.

8. A circuit as recited in claim 7 wherein said emitter lead is connected to a positive input lead.

9. A circuit as recited in claim 8 wherein said positive input lead engages a positive terminal on the DC power supply.

10. A circuit as recited in claim 9 wherein said collector lead is connected in series to a primary coil of said dual coil transformer.

11. A circuit as recited in claim 10 wherein said primary coil is further connected in series to an input ground.

12. A circuit as recited in claim 11 wherein said transistor further comprises a base lead connected to said outer circuit disposed to at least partially allow said inner and outer circuits to operatively associate.

13. A circuit as recited in claim 1 wherein said diode is structured to minimize high frequency generation by said circuit.

14. A circuit as recited in claim 13 wherein said outer circuit comprises a combination of said diode in parallel with a second standard capacitor.

15. A circuit as recited in claim 14 wherein said outer circuit further comprises a positive input lead engaging a positive terminal of the DC power supply.

16. A circuit as recited in claim 15 wherein said outer circuit includes a first standard capacitor connected in series to said positive input lead.

17. A circuit as recited in claim 16 wherein said outer circuit further comprises a secondary coil of said transformer disposed to amplify a voltage applied by the DC power source.

18. A circuit as recited in claim 17 wherein said secondary coil is further disposed to transfer said amplified voltage from said circuit through a positive output lead.

19. A circuit as recited in claim 18 wherein outer circuit further comprises a third standard capacitor connected in series between said positive output lead and an output ground, said third standard capacitor structured to further minimize high frequency generation by said circuit.

20. A circuit as recited in claim 19 wherein said electrolytic capacitor is disposed to filter a current through said circuit.

21. A circuit as recited in claim 20 wherein said electrolytic capacitor is connected to said outer circuit in series between an input ground and said positive input lead.

22. A circuit as recited in claim 21 wherein said at least one resistor comprises a first connection between a primary coil and a common ground and a second connection between said first standard capacitor and an interconnection of a base lead of said transistor to said outer circuit.

23. A circuit as recited in claim 1 wherein said transistor is type TiP 41.

24. A circuit as recited in claim 1 wherein said transistor is type TiP 42.

25. A circuit as recited in claim 1 wherein said transistor is type 2955.

26. A circuit as recited in claim 1 wherein said transistor is type 2956.

27. A circuit as recited in claim 1 wherein said diode is structured to operate at approximately 1000V between 1.0 A and 1.5 A.

28. A circuit as recited in claim 1 wherein said resistor is rated from approximately 120 kΩ to 1 MΩ.

29. A circuit as recited in claim 1 wherein said electrolytic capacitor is rated from approximately 47 μF to 200 μF.

30. A circuit as recited in claim 1 wherein said electrolytic capacitor is polarized.

31. A circuit as recited in claim 1 wherein said electrolytic capacitor is not polarized.

32. A circuit as recited in claim 19 wherein said first standard capacitor, said second standard capacitor and said third standard capacitor are rated from approximately 0.001 μF to 0.056 μF, 0.01 μF to 0.056 μF and 0.18 μF to 0.33 μF, respectively.

33. A circuit as recited in claim 5 wherein said primary coil comprises a straight ferrous bar core having approximately 25 to 50 windings of wire having a diameter between 0.20 mm and 0.50 mm and said secondary coil comprises a straight ferrous bar core having approximately 450 to 850 windings of wire having a diameter between 0.18 mm and 0.30 mm.

34. A circuit as recited in claim 5 wherein said primary coil comprises a closed loop ferrous nucleus core having approximately 10 to 30 windings of wire having a diameter between 0.20 mm and 0.50 mm and said secondary coil comprises a closed loop ferrous nucleus core having approximately 250 to 450 windings of wire having a diameter between 0.15 mm and 0.30 mm.

35. A circuit as recited in claim 33 wherein said wire comprises coated copper wire.

36. A circuit as recited in claim 34 wherein said wire comprises coated copper wire.

37. A circuit as recited in claim 1 further comprising a second resistor bridging a positive output lead and an output ground.

38. A circuit as recited in claim 1 further comprising an electronic voltage regulator connected in series between a positive terminal of the DC power supply and a positive input lead of said circuit.

39. A circuit as recited in claim 38 wherein said electronic voltage regulator comprises a voltage regulator transistor chip.

40. A circuit for an electronic voltage convertor for low current electrical equipment, said circuit comprising:
a) an inner circuit operatively associated with an outer circuit;
b) a positive input lead connected to said inner and outer circuits and engaging a positive terminal of a DC power supply;
c) said inner circuit comprising a transistor having an emitter lead connected to said positive input lead, a collector lead connected to a primary coil of a dual coil transformer, and a base lead interconnected to said outer circuit allowing said inner and outer circuits to be at least partially operatively associated;
d) said transistor structured to transfer energy from the DC power supply to said primary coil, wherein said primary coil is further connected to a common ground of said circuit;
e) said outer circuit comprising a first standard capacitor connected in series between said positive input lead and a combination of a diode connected in parallel with a second standard capacitor, wherein said diode is structured to minimize high frequency generation by said circuit;
f) said dual coil transformer having a secondary coil connected in series to said combination and being operatively associated with said primary coil, wherein said secondary coil is disposed to amplify a voltage applied to said primary coil and transfer said amplified voltage to a positive output lead of said circuit;
g) said outer circuit further comprising a third standard capacitor connected in series between said positive output lead and said common ground, said third standard capacitor structured to further minimize high frequency generation by said circuit;
h) said outer circuit further comprising an electrolytic capacitor disposed in series between said common ground and said positive input lead, wherein said electrolytic capacitor is structured to filter the current of said circuit; and
i) said circuit comprising at least one resistor having a first connection between said primary coil and said common ground and a second connection between said first standard capacitor and said interconnection of said base lead with said outer circuit, wherein said resistor at least partially defines operative association between said inner and outer circuits.

41. A circuit as recited in claim 40 wherein said transistor is type TiP 41.

42. A circuit as recited in claim 40 wherein said transistor is type TiP 42.

43. A circuit as recited in claim 40 wherein said transistor is type 2955.

44. A circuit as recited in claim 40 wherein said transistor is type 2956.

45. A circuit as recited in claim 40 wherein said diode is structured to operate at approximately 1000V between 1.0 A and 1.5 A.

46. A circuit as recited in claim 40 wherein said resistor is rated from approximately 120 kΩ to 1 MΩ.

47. A circuit as recited in claim 40 wherein said electrolytic capacitor is rated from approximately 47 μF to 200 μF.

48. A circuit as recited in claim 47 wherein said electrolytic capacitor is polarized.

49. A circuit as recited in claim 47 wherein said electrolytic capacitor is not polarized.

50. A circuit as recited in claim 40 wherein said first standard capacitor, said second standard capacitor and said third standard capacitor are rated from approximately 0.001 μF to 0.056 μF, 0.01 μF to 0.056 μF and 0.18 μF to 0.33 μF, respectively.

51. A circuit as recited in claim 40 wherein said primary coil comprises a straight ferrous bar core having approximately 25 to 50 windings of wire having a diameter between 0.20 mm and 0.50 mm and said secondary coil comprises a straight ferrous bar core having approximately 450 to 850 windings of wire having a diameter between 0.18 mm and 0.30 mm.

52. A circuit as recited in claim 40 wherein said primary coil comprises a closed loop ferrous nucleus core having approximately 10 to 30 windings of wire having a diameter between 0.20 mm and 0.50 mm and said secondary coil comprises a closed loop ferrous nucleus core having approximately 250 to 450 windings of wire having a diameter between 0.15 mm and 0.30 mm.

53. A circuit as recited in claim 51 wherein said wire comprises coated copper wire.

54. A circuit as recited in claim 52 wherein said wire comprises coated copper wire.

55. A circuit as recited in claim 40 further comprising a second resistor bridging said positive output lead and an output ground.

56. A circuit as recited in claim 40 further comprising an electronic voltage regulator connected in series between the positive terminal of the DC power supply and said positive input lead.

57. A circuit as recited in claim 56 wherein said electronic voltage regulator comprises a voltage regulator transistor chip.
